(19) United States
(12) Patent Application Publication
(10) Pub. No.: US 2016/0090028 A1
(43) Pub. Date: Mar. 31, 2016

(54) Trailer Lighting System

(71) Applicant: Tim Krejci, Missouri City, TX (US)

(72) Inventor: Tim Krejci, Missouri City, TX (US)

(73) Assignee: KREJCI SLICK STICKS, LLC, Missouri City, TX (US)

(21) Appl. No.: 14/498,347

(22) Filed: Sep. 26, 2014

(51) Int. Cl. B60Q 1/30; B60Q 1/26; B60Q 1/44

(52) U.S. Cl. CPC B60Q 1/305; B60Q 1/44; B60Q 1/2653; B60Q 1/2607

(57) ABSTRACT

An illustrative trailer lighting system including a pair of light posts arranged near the back of a trailer, wherein the pair of light posts includes a first light post arranged on the first side of the trailer at a distance from the back, and a second light post arranged on a second side of the trailer at substantially the same distance from the back, wherein the light posts each include a cavity therein, and wherein the light posts are a metal. The system further includes a first light having a generally transparent first light cover arranged at the top of each of the light posts, thereby visually indicating the location of the top of the light posts, and a second light having a generally transparent second light cover arranged in an upper portion of each of the light posts and at least partially embedded within the light posts, wherein the second light faces an area behind the trailer.

### TECHNICAL FIELD

The present disclosure relates to a trailer lighting system. More particularly, it relates to a system that includes a pair of metal light posts arranged on a trailer and having first a light arranged at the top and a second light arranged in an upper portion of the light post to provide visual indication of the trailer boundaries and illuminate an area behind the trailer.

### BACKGROUND

Trailers are used to tow and carry a variety of objects, such as all-terrain vehicles (ATVs), motorcycles, and personal watercraft. Maneuvering such trailers can present many problems. For example, when maneuvering a watercraft trailer to load or unload the watercraft therefrom, the trailer must first be backed down a ramp and submerged into the water. Performing such maneuvering presents many problems for both the vehicle driver and watercraft driver when loading and unloading the watercraft from the trailer. For example, the rear brake lights on the trailer are arranged near the wheel well or other low point on the trailer. This presents a problem, especially at night, due to the brake lights becoming submerged in the water upon the trailer being positioned accordingly to enable loading or unloading of the watercraft thereon.

The brake lights being submerged presents a problem for the vehicle driver due to no longer having a lit visual indicator of where the end of the trailer is or how deep the trailer is in the water. While some trailers have guide posts to assist and guide the watercraft during loading and unloading from the trailer, these posts are void of lights, therefore failing to rectify the problem during the evening or at night when dark outside. Moreover, such guideposts are typically cheap plastic which may bend or brake if contacted too strenuously by the watercraft, for example, by driver error or large waves or wakes from other boats.

The brake lights being submerged also presents many problems for the boat driver, especially at night. For example, similar to the vehicle driver, the boat driver too also has no indication of where the end of the trailer is, or the trailer overall for that matter. Moreover, when a boat ramp is crowded in the evening or when dark outside, a boat driver may easily confuse trailers and come dangerously close to loading into the wrong boat trailer before realizing such a mistake, then having to back-out into the water and line-up with the proper trailer. Therefore, there remains a need for a lighting system that generally assists viewing and awareness of the trailer boundaries. Such a lighting system may help reducing or alleviating at least the aforementioned problems when applied to a watercraft trailer.

### SUMMARY OF THE INVENTION

The present disclosure relates to a trailer lighting system that includes a pair of metal light posts arranged on a trailer that include a first light arranged at the top and a second light arranged in an upper portion of the light post to provide visual indication of the trailer boundaries.

An illustrative system includes a pair of light posts arranged near the back of the trailer, with a first light post on a first side of the trailer and a second light post on a second side of the trailer, the light posts being arranged substantially the same distance from the back of the trailer. The light posts each include a cavity therein, and are composed of a metal material. The light posts each include a first light having a substantially transparent first light cover arranged at the top of the light post, thereby visually indicating the location of the top of the light post. The light posts each further include a second light have a generally transparent second light cover arranged in an upper portion of the light posts, wherein the second light faces an area behind the trailer.

In some embodiments, the light posts may be constructed of an aluminum, anodized aluminum, or stainless steel. In other embodiments, the light posts may include a wiring harness and wiring running to the first and second lights via the light post cavity. In further embodiments, the trailer may be a watercraft trailer, and the light posts may further include a roller arranged thereon at approximately the mid-height of the light post, thereby reducing friction when a watercraft is loaded or unloaded from the trailer.

In some embodiments, the light posts may include a recessed area having the second light arranged therein. In further embodiments, the lights may be light emitting diodes (LEDs). In other embodiments, the second light may be a red hue, or the second light cover may be a red hue, thereby causing light emitted therefrom to be a red hue. Similarly, in other embodiments, the first light or light cover may be a clear or white hue.

In some embodiments, the light posts may have walls of a thickness ranging from 1/16 inch to ¼ inch. In further embodiments, the light posts may include a hole near the bottom, and the system further includes a means for securing the light post to the trailer, the means including a securing mechanisms with a custom head and a tool with a corresponding custom tool head for interacting with the securing mechanism.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 illustrates trailer lighting system, according to one or more embodiments.

FIG. 2 illustrates an enlarged angled-view of one of the light posts of the trailer lighting system, according to one or more embodiments.

FIG. 3 illustrates an enlarged angled-view of one of the light posts of the trailer lighting system having a roller and recessed area for lights, according to one or more embodiments.

FIG. 4 illustrates a cross-sectional view of one of the light posts, according to one or more embodiments.

FIG. 5 illustrates a means for securing the light post to the trailer, according to one or more embodiments.

### DETAILED DESCRIPTION

The present disclosure relates to a system that includes a pair of metal light posts arranged on a trailer that include a first light arranged at the top and a second light arranged in an upper portion of the light post to provide visual indication of the trailer boundaries.

An illustrative system includes a pair of light posts arranged near the back of the trailer, with a first light post on a first side of the trailer and a second light post on a second side of the trailer, the light posts being arranged substantially the same distance from the back of the trailer. The light posts each include a cavity therein, and are composed of a metal material. The light posts each include a first light having a substantially transparent first light cover arranged at the top of the light post, thereby visually indicating the location of the top of the light post. The light posts each further include a second light have a generally transparent second light cover arranged in an upper portion of the light posts, wherein the second light faces an area behind the trailer.

In some embodiments, the light posts may be constructed of an aluminum, anodized aluminum, or stainless steel. In other embodiments, the light posts may include a wiring harness and wiring running to the first and second lights via the light post cavity. In further embodiments, the trailer may be a watercraft trailer, and the light posts may further include a roller arranged thereon at approximately the mid-height of the light post, thereby reducing friction when a watercraft is loaded or unloaded from the trailer.

In some embodiments, the light posts may include a recessed area having the second light arranged therein. In further embodiments, the lights may be light emitting diodes (LEDs). In other embodiments, the second light may be a red hue, or the second light cover may be a red hue, thereby causing light emitted therefrom to be a red hue. Similarly, in other embodiments, the first light or light cover may be a clear or white hue.

In some embodiments, the light posts may have walls of a thickness ranging from 1/16 inch to ¼ inch. The light posts may be welded, bolted, or screwed to the trailer. Moreover, in some embodiments, the light posts may include a hole near the bottom, and the system further includes a means for securing the light post to the trailer, the means including a securing mechanisms with a custom head and a tool with a corresponding custom tool head for interacting with the securing mechanism, thereby preventing unwanted removal or theft of the light posts.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

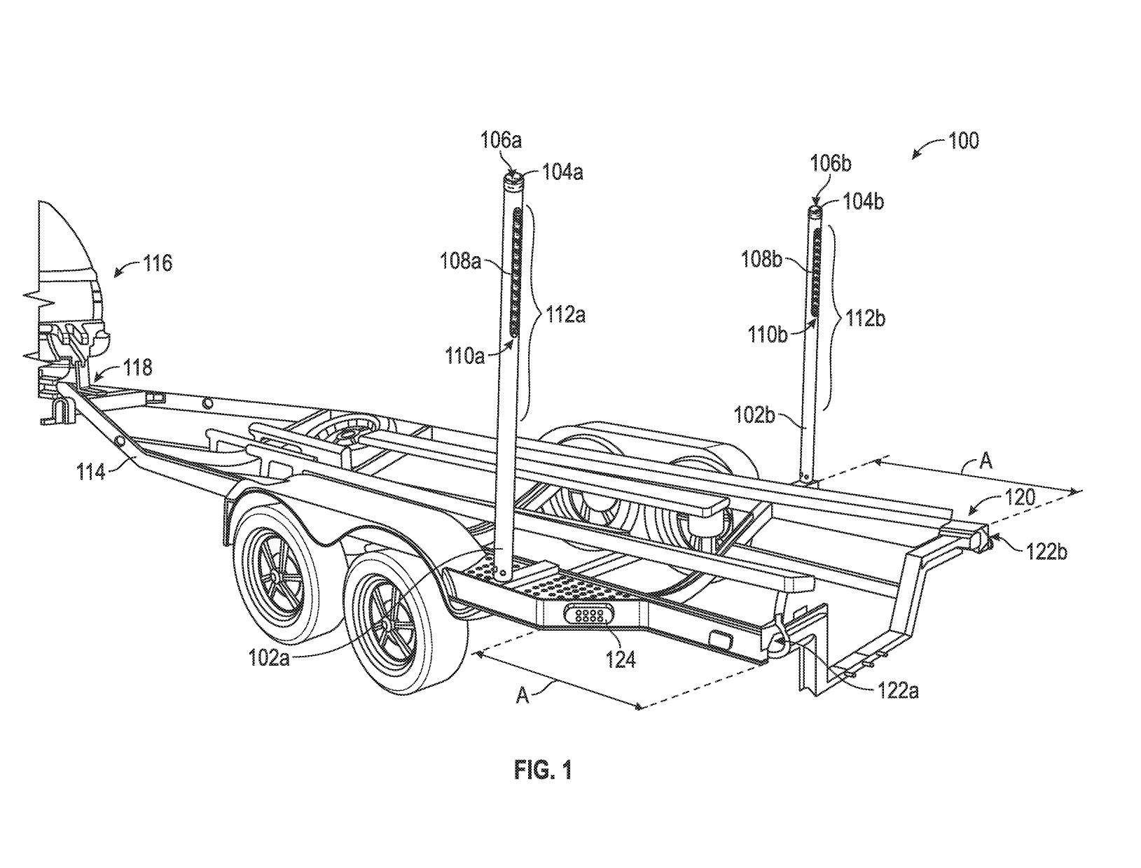

FIG. 1 illustrates a trailer lighting system 100, according to one or more embodiments. As depicted, the lighting system 100 includes a first light post 102a and a second light post 102b. The light posts 102a and 102b are generally hollow and manufactured from a metal, for example, aluminum (including an anodized aluminum) or stainless steel. The first light post 102a includes a first light 104a having a generally transparent first light cover 106a arranged at the top of the light post 102a, thereby enabling visual indication of the location of the top of the light post 102a. The first light post 102a further includes a second light 108a having a generally transparent second light cover 110a. The second light 108a and second light cover 110a are arranged at an upper portion 112a of the first light post 102a, for example, anywhere at a height equal to or above half of the length of the light post 102a. The second light post 102b also has a first light 104b and first light cover 106b, second light 108b and second light cover 110b, as discussed above for the first light post 102a.

FIG. 1 also depicts a trailer 114 coupled to a vehicle 116. The trailer is comprised of a front end 118, a back end 120, a first side 122a, and a second side 122b. As depicted, the first light post 102a is arranged on the first side 122a of the trailer 114, a distance A from the back end 120, and the second light post 102b is arranged on the second side 122b of the trailer 114, also a distance A from the back end 120. The light posts 102a and 102b may be coupled to the trailer 114 by employing a variety of techniques, for example and without limitation, welding, bolting, or screwing the light posts 102a and 102b to the trailer 114. Alternatively, or in addition thereto, the light posts 102a and 102b may be coupled to the trailer as described in further detail below (FIG. 5). The trailer 114 includes brake lights 124 attached to the base of the trailer near ground level, as typically included in trailers as required by most state laws.

Such a lighting system 100 has numerous advantages. For example, when arranged on a boat trailer, such as trailer 114, the first lights 106a,b enable the driver of the vehicle 116 to have a visual indication of the trailer 114 boundaries, thereby enabling more accurate maneuvering of the trailer 114 than without such first lights 106a,b. The second lights 108a,b may be brake lights which illuminate in synchronization with the brake lights 124, however, while the brake lights 124 become submerged under water when the trailer 114 is configured in the water for watercraft deployment or retrieval, the second lights 108a,b remain above water. Such is advantageous for both the vehicle 116 driver and watercraft driver. Having the second lights 108a,b above water enables the vehicle 116 driver to have an approximation of how deeply submerged the trailer 114 is. Additionally, the second lights 108a,b enable the watercraft driver to safely guide the watercraft on or off of the trailer 114 by both giving a visual indication as to the boundaries of the trailer 114, and also illuminating an area of water to prevent collision with objects that may be floating.

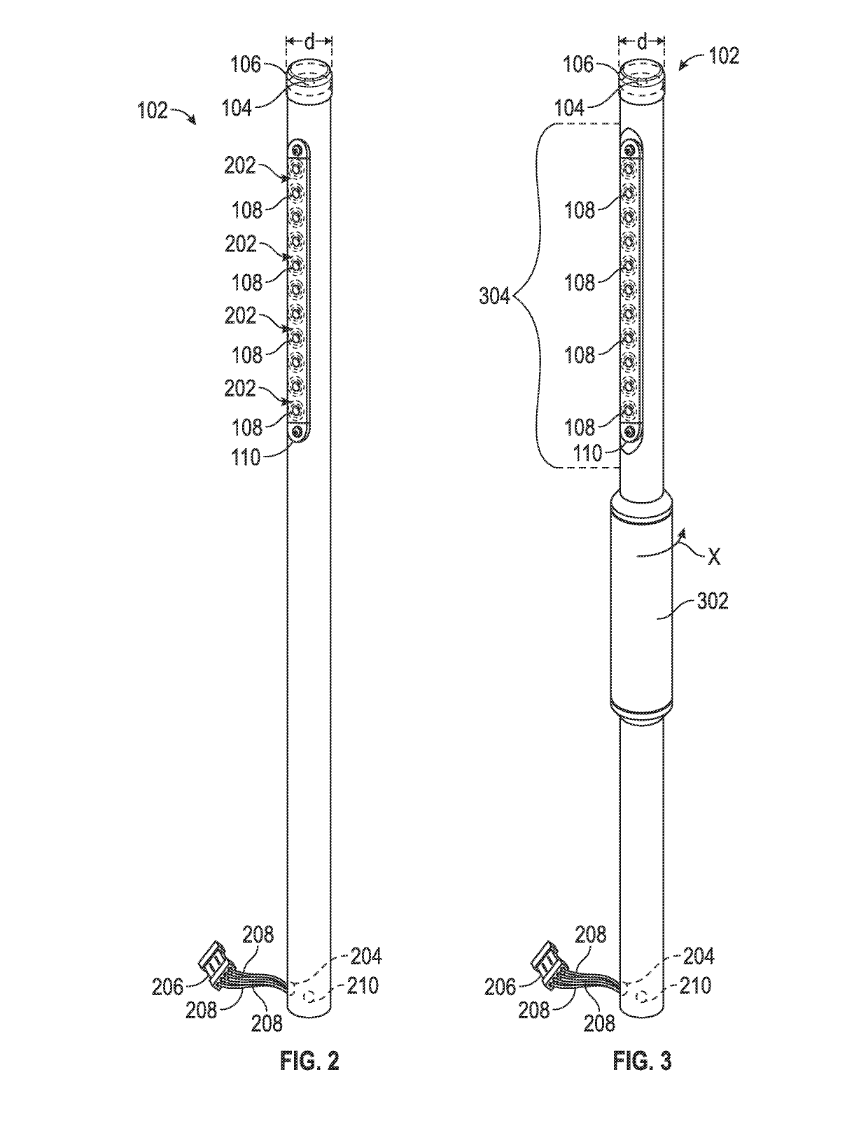

FIG. 2 illustrates an enlarged angled-view of one of the light posts 102 of the trailer lighting system, according to one or more embodiments. In some embodiments, and as depicted, the lighting post 102 includes the first light 104 and first light cover 106, and a plurality of second lights 108 (for example, three, five, eleven, etc. lights 108) and a second light cover 110 which covers the plurality of second lights 108. In some embodiments, the light posts 102 may be circular in nature, however the light posts may take other shapes in other embodiments, such as square, hexagonal, or the like.

In some embodiments, the first light cover 106 may be substantially the same dimensions as the light post 102. For example, the light post 102 of FIG. 2 has a diameter d, and the first light cover 106 is approximately the same diameter d. However, in other embodiments, the first light cover 106 may be larger or smaller dimensions from the light post 102, without departing from the scope of the present disclosure.

In some embodiments, the first light 104 and the first light cover 106 together or separately may cause the light emitted to be of a clear or white hue. For example, in some embodiments, the first light 104 may be white and the first light cover 106 may be transparent. In other embodiments, the first light cover 106 may be a white hue, thereby causing the light emitted from the first light 104 to appear to be a white hue.

Similarly, in some embodiments, the second light 108 and/or the second light cover 110 may cause the light emitted therefrom to be a certain color or hue, such as red (when the second light 108 is being used as a brake light). Such a red hue may be emitted due to the second light 108 being of a red hue or including a red coating, therefore emitting a red hue. In other embodiments, the second light cover 100 may be of a red tint or hue, thereby causing the light emitted from the second light 108 (or plurality thereof) to be visually represented as a red hue. In some embodiments, the first light 104 and/or the second light 108 may be a light emitting diode (LED), therefore capable of generating colored light.

In some embodiments, the second light cover 110 may be designed as to visually represent the second light 108 (or each of the second lights 108) as being circular in nature 202 (shown in dashed). In further embodiments, such as where the trailer 114 is for a watercraft, the second light cover 100 may for a substantially water-tight seal with the light post, thereby precluding water from entering the light post near the second light 108.

The lighting system 100 may further include a wiring harness or adapter 206 coupled to wires 208 that run through a wiring hole 204 near the bottom of the light post 102, through the light post 102, and to the first light 104 and second light (or plurality of second lights) 108. The wiring harness is capable of mating with a wiring harness from the trailer 114 or vehicle 116 which control electrical signals sent through the wires 208 to the lights 104, 108.

FIG. 3 illustrates an enlarged angled-view of one of the light posts 102 of the trailer lighting system 100 having a roller 302 and recessed area 304 for the lights, according to one or more embodiments. As depicted, similar to FIGS. 1-2, the light post 102 is generally circular in nature. However, the light post further includes a recessed area 304 in which the second light(s) 108 and second light cover 110 are arranged. Advantageously, such an arrangement may help to protect the second light(s) 108 from damage due to being recessed, and therefore accessible and harder to scratch, brake, or damage.

The light post 102 in FIG. 3 further includes a roller 302. In some embodiments, especially where the trailer 114 is a watercraft trailer, the roller 302 is arranged at approximately a mid-height of the light post 102 due to this being a likely point of contact for the watercraft when being loaded or unloaded between the watercraft and the water. The roller 302 is freely movable, such as in a first direction X, but also in a direction opposite of X. Advantageously, such a roller 302 reduces friction when the watercraft comes in contact therewith during the loading or unloading process.

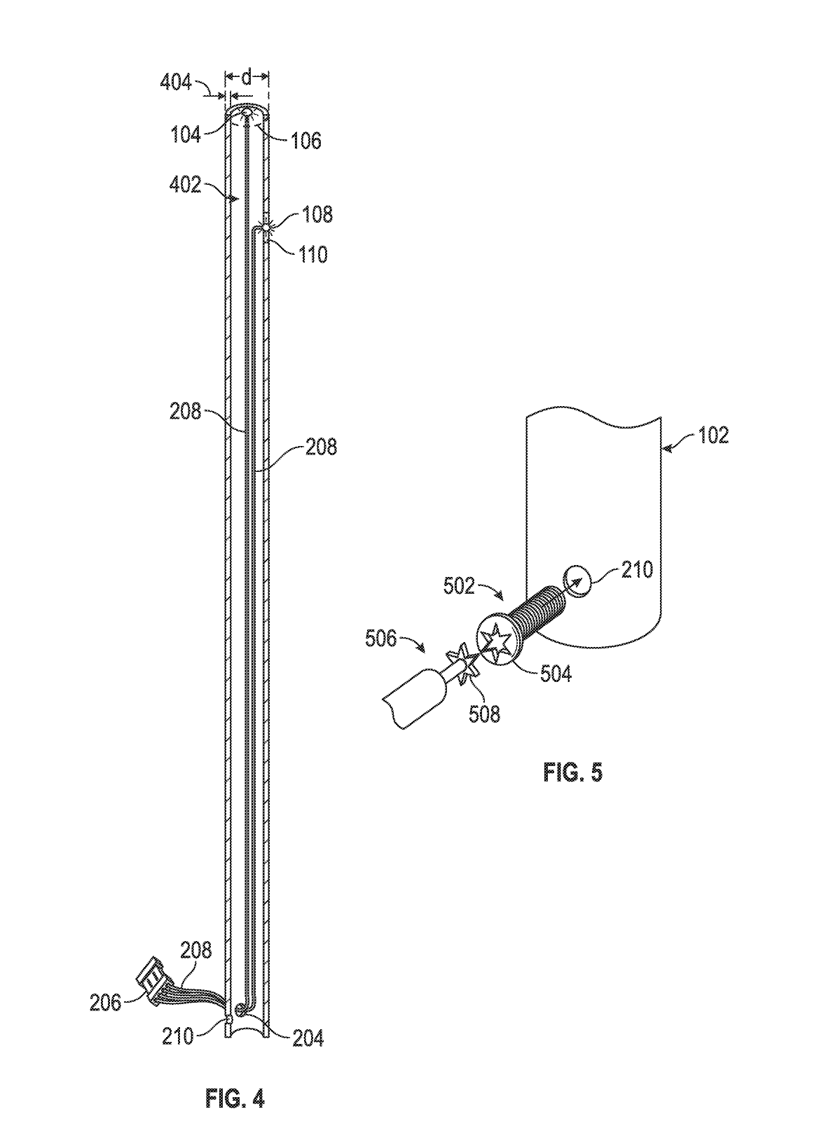

FIG. 4 illustrates a cross-section view of one of the light posts 102, according to one or more embodiments. FIG. 4 depicts the light post 102 with an overall diameter d, and further depicts the light post wall thickness 404. In some embodiments, the wall thickness 404 may range from 1/16 inch thick to ¼ inch thick, with a greater wall thickness 404 being advantageous for strength of the light post 102. As previously mentioned, the first light cover 106 may be an approximately equal diameter d as the light post 102. Alternatively, the first light cover 106 may be larger or smaller diameter, as may be advantageous to increase visibility of the first light cover 106, and thus the boundaries of the trailer 114.

The light post 102 includes a cavity 402 on the interior of the light post 102. Inclusion of such a cavity is advantageous by reducing weight of the light post 102, but also enables wires 208 to be run from the wiring harness 206 to the first light 104 and second light 108.

FIG. 5 illustrates a means for securing the light post 102 to the trailer 114, according to one or more embodiments. In some embodiments, as depicted, such means includes a securing mechanism 502 with a custom head 504, and a tool 506 with a tool head 508. The custom head 504 is a non-standard design pattern, to which the tool head 508 is correspondingly designed to interact with. In some embodiments, the securing mechanism may be a bolt or screw. Example configurations of the custom head, as depicted, may resemble a star-shaped pattern. However, numerous other embodiments and configurations will be appreciated by those skilled in the art, including more or less spokes of the star, rounded edges, and other designs uneasily replicated.

While embodiments discussed herein discussed the present invention with relationship to watercraft, it will be appreciated by those skilled in the art that such invention can easily be applied to other trailers, for example and without limitation, trailers for moving all-terrain vehicle (ATVs) or motorcycles trailers.

Although the disclosure has been described and illustrated with respect to exemplary objects thereof, it will be understood by those skilled in the art that various other changes, omissions, and additions may be made therein and thereto without departing from the scope of the present disclosure. Moreover, it will be appreciated by those skilled in the art that the above illustrations are not necessarily to size or scale, and thus the present disclosure should accordingly not be interpreted as such.

What is claimed is:

1. A trailer lighting system, comprising:
a pair of light posts arranged near the back of a trailer, wherein the pair of light posts includes a first light post arranged on the first side of the trailer at a distance from the back, and a second light post arranged on a second side of the trailer at substantially the same distance from the back,
wherein the light posts each include a cavity therein,
wherein the light posts are a metal;
a first light having a generally transparent first light cover arranged at the top of each of the light posts, thereby visually indicating the location of the top of the light posts; and
a second light having a generally transparent second light cover arranged in an upper portion of each of the light posts and at least partially embedded within the light posts, wherein the second light faces an area behind the trailer.

2. The system of claim 1, where in the light posts are generally circular in nature.

3. The system of claim 1, wherein the metal is one of an aluminum, anodized aluminum, or stainless steel.

4. The system of claim 1, wherein each light post further includes a wiring harness and wiring running to the first and second lights via the associated cavity, the wiring harness capable of connecting to a mating wiring harness which supplies electrical signals to the first and second lights.

5. The system of claim 1, wherein the trailer is a watercraft trailer.

6. The system of claim 5, wherein each of the light posts further comprises a roller arranged thereon at approximately the mid-height of the light post, thereby reducing friction when a watercraft is loaded or unloaded from the trailer.

7. The system of claim 5, wherein the second light cover forms a substantially water-tight seal with the light post, thereby precluding water from entering the light post near the second light.

8. The system of claim 1, wherein the light posts each include a recessed area having the second light arranged therein.

9. The system of claim 1, wherein the first light and second light is a light emitting diode (LED).

10. The system of claim 1, wherein the second light emits a red hue, thereby causing the light emitted from the second light to be a red hue.

11. The system of claim 1, wherein the second light cover is a red hue, thereby causing the light emitted from the second light to be a red hue.

12. The system of claim 1, wherein the first light cover is one of clear or white hue.

13. The system of claim 1, wherein the first light cover is substantially the same dimensions as the light post.

14. The system of claim 1, wherein the second light cover visually represents the second light to be circular in nature.

15. The system of claim 1, wherein the wall thickness of each light post is within the range of 1/16 inch to ¼ inch.

16. The system of claim 1, wherein each light post is one of welded, bolted, or screwed to the trailer.

17. The system of claim 1, wherein each light post further includes a hole near the bottom, and the system further comprises a means for securing the light post to the trailer, the means including a securing mechanisms with a custom head and a tool with a corresponding custom tool head for interacting with the securing mechanism.

18. The system of claim 17, wherein the securing mechanism is one of a screw or a bolt.

19. The system of claim 1, wherein the second light is a plurality of at least five lights.
